(19) United States
(12) Patent Application Publication
(10) Pub. No.: US 2013/0061874 A1
(43) Pub. Date: Mar. 14, 2013

(54) Cap Sanitizer and Method of Use Thereof

(71) Applicant: Pamela Woolery, Macon, GA (US)

(72) Inventor: Pamela Woolery, Macon, GA (US)

(21) Appl. No.: 13/228,484

(22) Filed: Sep. 9, 2011

(51) Int. Cl. B08B 1/00; B08B 3/00

(52) U.S. Cl. 134/6; 15/104.92

(57) ABSTRACT

A cap sanitizer with an anti-bacterial sponge therein for sanitizing a dispenser bottle tip or other similar device. The inner side portions of the cap are lined with a continuous sponge (or absorbent foam) ring soaked with antibacterial solution. An o-ring is disposed below the sponge to prevent solution from leaking from the dispenser bottle when the cap is in place. A cavity within the dispenser cap serves as a reservoir for the antibacterial solution, which is slowly channeled to the sponge ring via a perforated separating film. Alternatively, the reservoir may be disposed between the sponge and the sides of the dispenser cap sanitizer, with a perforated separating film between the sponge and the antibacterial solution. Solution from the reservoir is channeled through the perforated separating film into the sponge. In an alternative, a sanitizer cap for a toothbrush is provided having stiff fibers extending through the perforated membrane.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to apparatuses for sanitizing implements, and more specifically to a sanitizing cap for automatically sanitizing the tip of dispenser bottles after each use.

2. Description of Related Art

Various liquid chemical ingredients are dispensed via dispenser bottles that are utilized for multiple applications.

One previous device comprises a disinfectant cap for a sterile liquid dispenser. The cap is adapted with a biocide-containing pad that is fixed to the upper inner cap surface, and may extend partly or completely down the inner cap surface. Consequently, when the cap is secured to the liquid dispenser, the pad either partly or completely covers the dispensing element thereby sterilizing it. In one embodiment, this previous device describes the cap being further adapted with a hollow cavity near the cap's upper inner portion for storing a reservoir of liquid biocide, wherein the biocide is channeled into the pad. However, this device teaches utilizing a separate wick as the channeling means between the biocide reservoir and the pad; further, the pad contacts the tip of the dispenser which could lead to contamination of the solution being dispensed. Lastly, this device does not prevent leaking of the sanitizing material from the dispenser cap either when removed or in place.

Another device and method is for applying a cosmetic product, wherein the device comprises a cap that secures to a dispensing body portion via a neck portion. The cap is internally adapted with a sponge material, while the dispensing body portion is adapted with a product-containing reservoir. Upon securing the cap to the body portion, product from the reservoir soaks into the sponge material through a perforated separator within the neck portion. However, the reservoir, the perforated separator, and the sponge material are not all contained with the inner cap portion. Moreover, the device contains storage only for the product being dispensed and does not contain a separate solution for applying to the tip of the dispenser for cleaning and/or sanitizing.

Therefore, it is readily apparent that there is a need for a sanitizing cap for liquid chemical dispensers that does not contaminate the dispensing tip, but which sanitizes the major portion thereof.

### BRIEF SUMMARY OF THE INVENTION

Briefly described, in a preferred embodiment, the present invention overcomes the above-mentioned disadvantages and meets the recognized need for such a device by providing a cap sanitizer adapted with an anti-bacterial sponge for sanitizing the dispensing element of a dispensing bottle or other device. In a preferred embodiment, the inner side portions of the cap are lined with a continuous sponge (or foam) ring soaked with antibacterial solution. The end portions of the sponge ring have o-rings to prevent solution from leaking. Another preferred embodiment of the bottle cap has a similar structure to the first embodiment, except that it comprises a sponge-less inner tip portion that is utilized as a reservoir for antibacterial solution, wherein the solution is slowly channeled to the sponge ring via a perforated separating film.

An alternate embodiment of the cap sanitizer comprises three distinct layers lining the majority of the inner portion of the cap, the layers being sandwiched one on top of another, with the outermost layer comprising an antibacterial solution reservoir, the middle layer comprising a perforated separating film, and the innermost layer comprising a sponge. Solution from the reservoir is channeled through the perforated separating film into the sponge.

Another alternate embodiment is a sanitizer cap for a toothbrush, similar to the preferred embodiment, wherein the sanitizer cap comprises an outer solution chamber defined on its innermost surface by a perforated membrane, with stiff fibers extending through the perforated membrane. When a toothbrush is inserted and rotated, it is cleansed by solution that flows down the stiff fibers.

According to its major aspects and broadly stated, the present invention in its preferred form is a cap sanitizer comprising a cap member with a bottom section, a middle section having a sidewall, and a top section. The cap sanitizer has a cavity with sanitizing solution therein that is disposed within the top and/or middle sections. The sanitizing solution is in fluid communication with an applying surface, such as, for exemplary purposes only a sponge or bristles, and reaches the applying surface through apertures in a perforated membrane, which, together with the middle section and/or top section, defines the boundary of the cavity. The apertures are around the periphery of the membrane.

An o-ring is disposed at the bottom section below the applying surface to seal against the tip of the dispenser bottle as the cap sanitizer is secured to the dispenser bottle. The cap sanitizer may include a second o-ring, disposed above the applying surface to seal against the dispenser bottle tip when said dispenser cap sanitizer is secured to the dispenser bottle, thereby preventing leakage of the sanitizing solution to the dispenser bottle tip orifice. After removal of the cap sanitizer and subsequent use of the dispenser bottle to dispense its contained ingredients, as the cap sanitizer is replaced over the dispenser bottle tip, the applying surface wipes the dispenser bottle tip, thereby sanitizing the dispenser bottle tip.

In an alternative embodiment, the applying surface may extend within said middle and top sections and cover the dispenser bottle tip orifice. In another alternative embodiment, the cap sanitizer comprises a toothbrush sanitizer that has for its applying surface, for exemplary purposes only, stiff fibers that pass through the perforated membrane and which engage the bristles of the toothbrush, thereby wiping the bristles with sanitizing solution that has passed through the perforated membrane and along the stiff fibers. In this embodiment, the toothbrush is inserted into the cap sanitizer and rotated to cause engagement of the bristles with the stiff fibers.

More specifically, the present invention is a cap sanitizer comprising a cap that has a bottom, a middle and a top. A cavity is disposed within the cap along with a perforated membrane, a sanitizing solution and a sponge having a top boundary. The perforated membrane has apertures therein. The bottom of the cap has internal threads on the inside thereof, and an internal groove that is dimensioned to receive an o-ring.

The o-ring is disposed below the sponge. Additionally, a second o-ring may optionally be disposed in a second groove above the sponge proximate the top boundary of the sponge. In either embodiment, the sanitizing solution directly contacts the top boundary of the sponge after the sanitizing solution passes through the apertures in the perforated membrane as the sanitizing solution exits the cavity. The perforated membrane does not have apertures directly over the orifice of the tip of the dispenser bottle in order to prevent contamination of the contents of the dispenser bottle by the sanitizing solution.

In use, the cap sanitizer is disposed on the dispensing bottle with the internal threads engaging the threaded stem of the dispensing bottle. As the cap sanitizer is installed over the tip of the dispenser bottle, the sponge wipes against the side of the tip, sanitizing same. Once the cap sanitizer is secured on the dispenser bottle tip, the lower o-ring contacts the stem top of the dispenser bottle, thereby sealing in the sanitizing solution and preventing same from leaking. In the alternative having a second o-ring, the second o-ring seals against the tip side when the cap sanitizer is secured on the dispenser bottle.

As the sanitizing solution is slowly utilized through repetitive removals/reinstallations of the cap sanitizer over the dispenser bottle, the sanitizing solution passes from the cavity through the apertures of the perforated membrane and rewets the sponge, thereby providing continued use of the cap sanitizer.

It will also be recognized by those skilled in the art that the cavity and the perforated membrane may be excluded, the cap sanitizer thereby relying only on a pre-wetted sponge to sanitize the tip.

The sponge could extend over the orifice of the tip. In this alternative embodiment, the sanitizing solution is initially contained in the cavity, then passes through the perforated membrane via the apertures, thereby wetting the sponge which extends within the middle section and the top section.

In an alternative embodiment, the dispenser tip sanitizer comprises a cap, a sanitizing solution, a sponge and a perforated membrane. The cap comprises a bottom, a middle and a top, and wherein the bottom comprises internal threads, and wherein the perforated membrane comprises apertures. The perforated membrane is disposed within the cap, wherein the apertures are disposed peripherally on the perforated membrane. Disposed internal to the bottom is a groove, wherein the groove is dimensioned to receive the o-ring. The top and middle portions of the cap comprise the cavity which is defined by the top, the middle and the perforated membrane with the sanitizing solution disposed within the cavity. The cavity and perforated membrane extend across the top and down the middle with the sanitizing solution disposed within the cavity, and the perforated membrane is disposed in contact with the sponge.

In use, the dispenser tip sanitizer is disposed on the dispensing bottle, the threads engaging the threaded stem of the dispensing bottle. As the dispenser tip sanitizer is installed over the tip of the dispenser bottle, the sponge wipes against side of the tip, sanitizing same. Once the dispenser bottle tip sanitizer is secured on the dispenser bottle tip, the o-ring contacts the stem top of the dispenser bottle, thereby sealing in the sanitizing solution and preventing same from leaking.

As the sanitizing solution is slowly utilized through repetitive removals/reinstallations of the dispenser tip sanitizer over the dispenser bottle, the sanitizing solution passes from the cavity through the apertures of the perforated membrane and rewets the sponge, thereby providing continued use of the dispenser tip sanitizer.

In another alternate embodiment, the cap sanitizer is a toothbrush sanitizing cap having a perforated membrane with apertures, a sanitizing solution and a body, the body comprising a bottom, a middle and a top, and wherein the bottom comprises a slit. The toothbrush sanitizing cap further comprises a cavity defined by the perforated membrane and the middle. Stiff fibers extend from the middle of the body through the cavity and/or the perforated membrane.

In use, the sanitizing solution flows along the stiff fibers through the perforated membrane. The toothbrush is inserted through the slit, which prevents spraying of the sanitizing solution when the head of the toothbrush is rotated by twisting the toothbrush as shown by the direction arrow. As the toothbrush is rotated, the bristles contact and engage the stiff fibers, thereby depositing the sanitizing solution on the bristles to cleanse the toothbrush.

Accordingly, a feature and advantage of the cap sanitizer is its ability to sanitize the tip of a dispenser bottle after each use.

Another feature and advantage of the cap sanitizer is its ability to be utilized with a variety of sanitizing solutions.

Still another feature and advantage of the cap sanitizer is its ability to fit a variety of profiles/shapes of solution bottle dispensing tips.

Yet another feature and advantage of the cap sanitizer is its ability to be replaced to replenish the sanitizing solution.

Yet still another feature and advantage of the cap sanitizer is that it can be utilized to sanitize a toothbrush.

A further feature and advantage of the cap sanitizer is that it is sealed against leaks when the sanitizer cap is in place on a dispensing bottle.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a cross-sectional side view of a cap sanitizer according to a preferred embodiment, shown installed on a dispenser bottle;

FIG. 1B is a perspective view of the cap sanitizer of FIG. 1A, with the cap exterior removed for clarity;

FIG. 2A is a cross-sectional side view of a cap sanitizer according to another preferred embodiment, shown installed on a dispenser bottle;

FIG. 2B is a perspective view of the cap sanitizer of FIG. 2A, with the cap exterior removed for clarity;

FIG. 3 is a cross-sectional side view of a cap sanitizer according to an alternate embodiment having the sponge portion extending over the tip of the applicator;

FIG. 4A is a perspective view of a sanitizing cap according to an alternate embodiment utilized for sanitizing the bristles of a toothbrush; and

FIG. 4B is a cross-sectional top view of the sanitizing cap of FIG. 4A.

### DETAILED DESCRIPTION OF THE PREFERRED AND SELECTED ALTERNATE EMBODIMENTS OF THE INVENTION

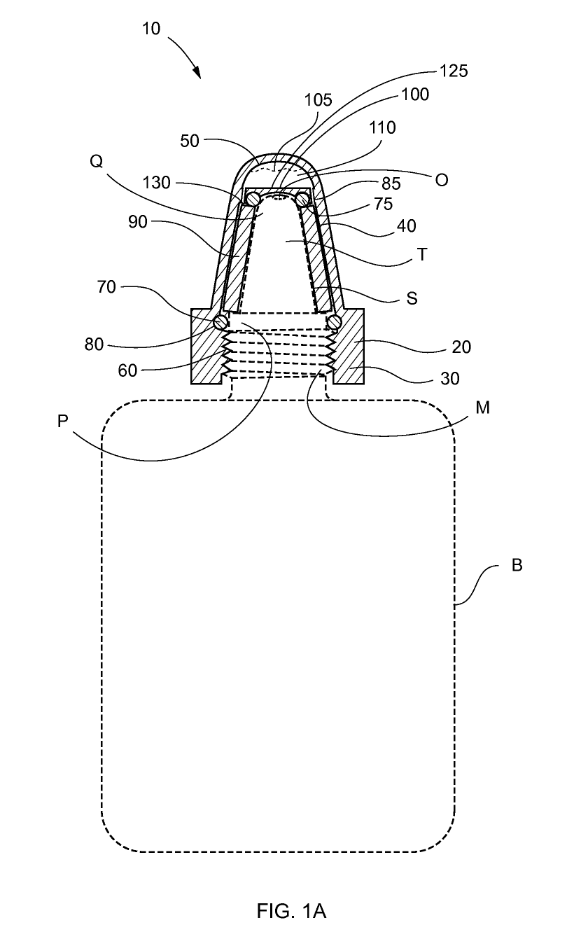

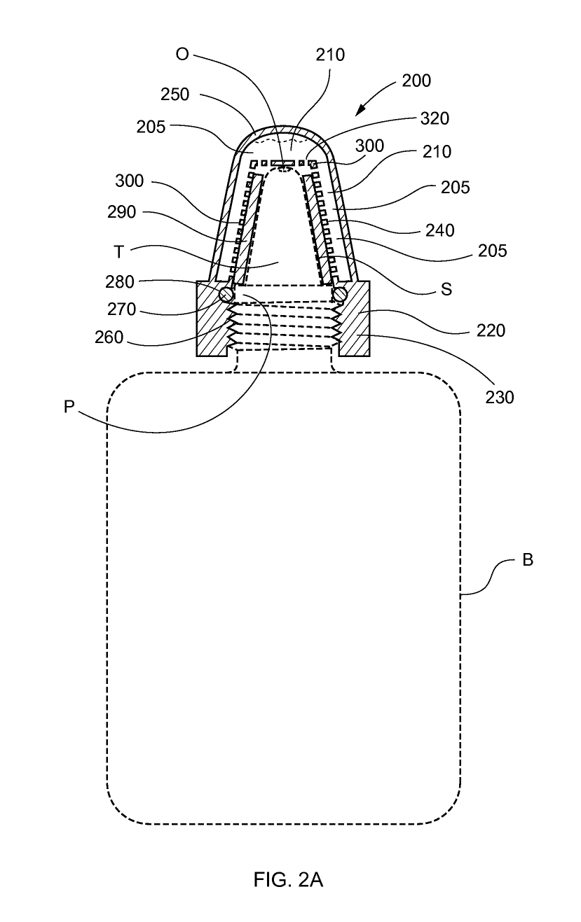

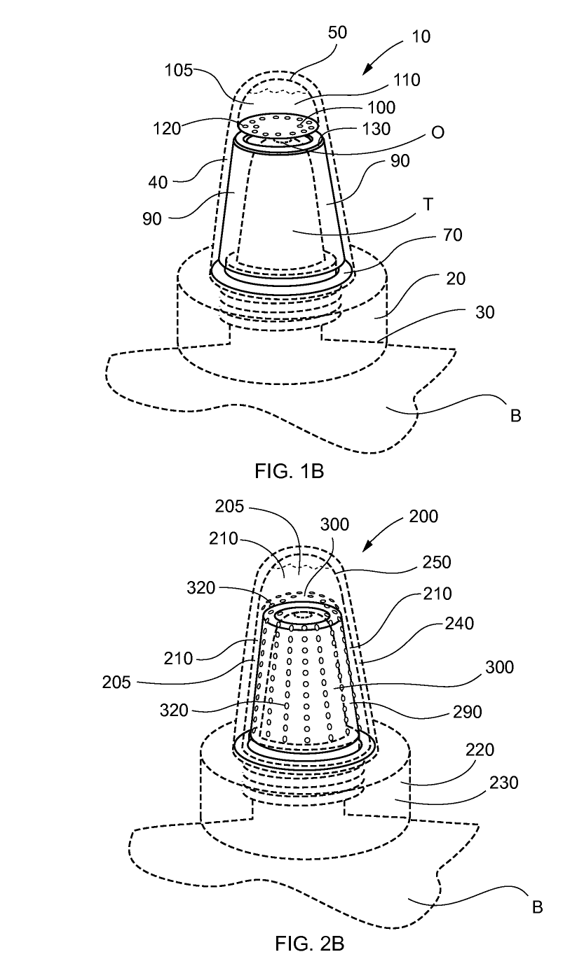

In describing the preferred and selected alternate embodiments of the present invention, as illustrated in FIGS. 1-4B, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-1B, the present invention in a preferred embodiment is cap sanitizer 10 comprising cap 20, wherein cap 20 comprises bottom 30, middle 40 and top 50. Within cap 20 is disposed an applying surface, such as, for exemplary purposes only, sponge 90, wherein sponge 90 comprises top boundary 130. Further disposed within cap 20 are perforated membrane 100, cavity 105 and sanitizing solution 110, wherein perforated membrane 100 comprises apertures 120, and wherein cavity 105 contains sanitizing solution 110. Bottom 30 comprises internal threads 60 and internal groove 80, wherein internal groove 80 is dimensioned to receive o-ring 70.

O-ring 70 is disposed within internal groove 80 below sponge 90. Additionally, second o-ring 75 may optionally be disposed in second groove 85, wherein second groove 85 is disposed proximate top boundary 130. In either embodiment, sanitizing solution 110 directly contacts top boundary 130 of sponge 90 after sanitizing solution 110 passes through apertures 120 from cavity 105.

In the preferred embodiment of FIGS. 1A-1B, perforated membrane 100 does not have apertures 120 directly over orifice O of tip T of dispenser bottle B, thereby being excluded from central section 125 in order to prevent contamination of contents of dispenser bottle B by sanitizing solution 110.

In use, cap sanitizer 10 is disposed on dispensing bottle B, wherein internal threads 60 engage threaded stem M of dispensing bottle B. As cap sanitizer 10 is installed over tip T of dispenser bottle B, sponge 90 wipes against side S of tip T, sanitizing same. Once cap sanitizer 10 is secured on dispenser bottle tip T, lower o-ring 70 contacts stem top P of dispenser bottle B, thereby sealing in sanitizing solution 110 and preventing same from leaking. In the alternative having second o-ring 75, second o-ring seals against tip side Q when cap sanitizer 10 is secured on dispenser bottle B.

As sanitizing solution 110 is slowly utilized through repetitive removals/reinstallations of cap sanitizer 10 over dispenser bottle B, sanitizing solution 110 passes from cavity 105 through apertures 120 of perforated membrane 100 and rewets sponge 90, thereby providing continued use of cap sanitizer 10.

It will also be recognized by those skilled in the art that cavity 105 and perforated membrane 100 may be excluded, cap sanitizer 10 thereby relying only on pre-wetted sponge 90 to sanitize tip T.

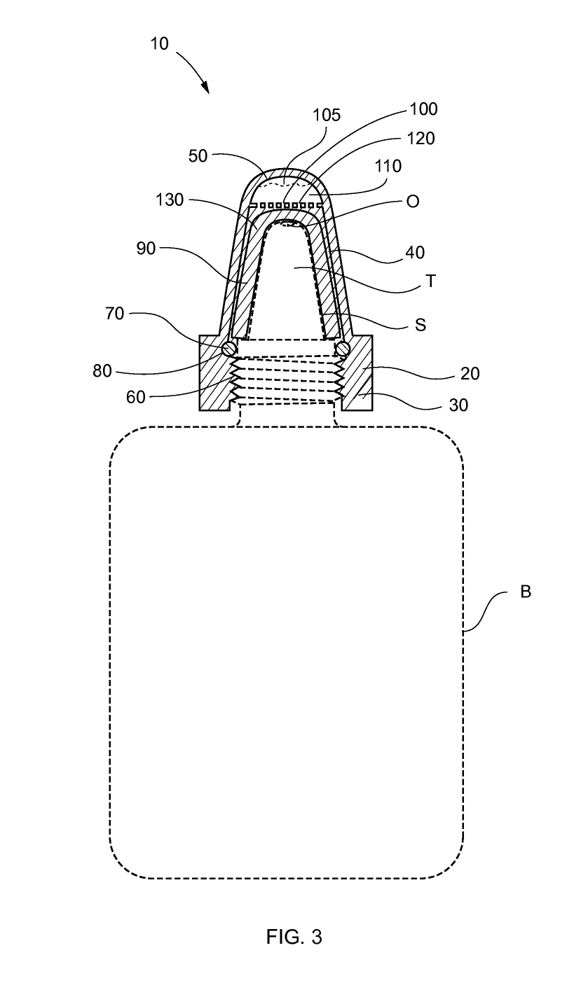

In an alternate configuration of the preferred embodiment of FIGS. 1A-1B depicted in FIG. 3, sponge 90 could extend over orifice O of tip T. In this alternative embodiment, sanitizing solution 110 contained in cavity 105, passes through perforated membrane 100 via apertures 120, thereby wetting sponge 90, when sponge 90 extends within middle section 40 and top section 50.

Referring now more specifically to FIGS. 2A-2B, illustrated therein is an alternate embodiment of cap sanitizer 10, wherein the alternate embodiment of FIGS. 2A-2B is substantially equivalent in form and function to that of the preferred embodiment detailed and illustrated in FIGS. 1A-1B and the alternative configuration of FIG. 3, except as hereinafter specifically referenced. Specifically, the embodiment of FIGS. 2A-2B comprises dispenser tip sanitizer 200. Dispenser tip sanitizer 200 comprises cap 220, sanitizing solution 210, sponge 290 and perforated membrane 300, wherein cap 220 comprises bottom 230, middle 240 and top 250, and wherein bottom 230 comprises internal threads 260, and wherein perforated membrane 300 comprises apertures 320. Perforated membrane 300 is disposed within cap 220, wherein apertures 320 are disposed peripherally on perforated membrane 300. Disposed internal to bottom 230 is groove 280, wherein groove 280 is dimensioned to receive o-ring 270. Top 250 and middle 240 comprise cavity 205, wherein cavity 205 is defined by top 250, middle 240 and perforated membrane 300, and wherein sanitizing solution 210 is disposed within cavity 205.

Cavity 205 and perforated membrane 300 extend across top 250 and down middle 240, wherein perforated membrane 300 is disposed in contact with sponge 290, and wherein sanitizing solution 210 is disposed within cavity 205.

In use, dispenser tip sanitizer 200 is disposed on dispensing bottle B, wherein threads 260 engage threaded stem M of dispensing bottle B. As dispenser tip sanitizer 200 is installed over tip T of dispenser bottle B, sponge 290 wipes against side S of tip T, sanitizing same. Once dispenser bottle tip sanitizer 200 is secured on dispenser bottle tip T, o-ring 270 contacts stem top P of dispenser bottle B, thereby sealing in sanitizing solution 210 and preventing same from leaking.

As sanitizing solution 210 is slowly utilized through repetitive removals/reinstallations of dispenser tip sanitizer 200 over dispenser bottle B, sanitizing solution 210 passes from cavity 205 through apertures 320 of perforated membrane 300 and rewets sponge 290, thereby providing continued use of dispenser tip sanitizer 200.

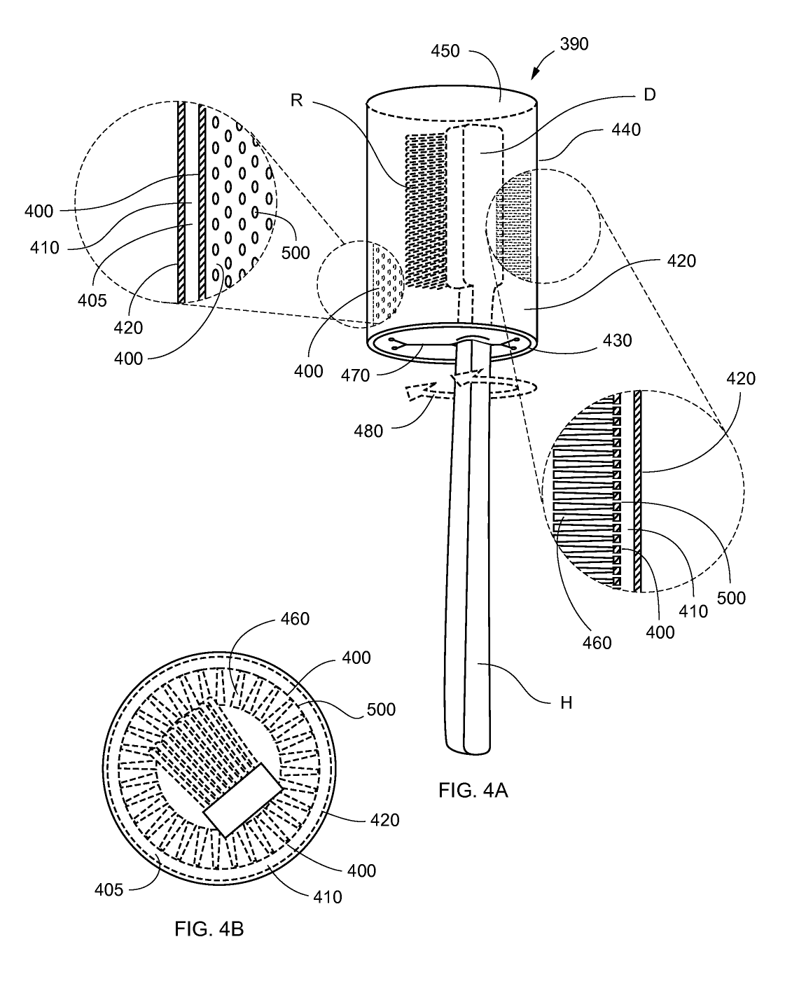

Referring now more specifically to FIGS. 4A-4B, illustrated therein is an alternate embodiment of cap sanitizer 10, wherein the alternate embodiment of FIGS. 4A-4B is substantially equivalent in form and function to that of the preferred and alternate embodiments detailed and illustrated in FIGS. 1A-1B, 2A-2B and 3, except as hereinafter specifically referenced. Specifically, the embodiment of FIGS. 4A-4B comprises toothbrush sanitizing cap 390, wherein toothbrush sanitizing cap 390 comprises perforated membrane 400 having apertures 500, sanitizing solution 410 and body 420, and wherein body 420 comprises bottom 430, middle 440 and top 450, and wherein bottom 430 comprises slit 470. Toothbrush sanitizing cap 390 further comprises cavity 405 defined by perforated membrane 400 and middle 440. Disposed extending from middle 440 of body 420 are stiff fibers 460, wherein stiff fibers 460 extend through cavity 405 and/or perforated membrane 400.

In use, sanitizing solution 410 flows along stiff fibers 460 through perforated membrane 400. Toothbrush H is inserted through slit 470, wherein slit 470 prevents spraying of sanitizing solution 410 when head D of toothbrush H is rotated by twisting toothbrush H as shown by direction arrow 480. As toothbrush H is rotated, bristles R contact and engage stiff fibers 460, thereby depositing sanitizing solution 410 on bristles R, thereby cleansing toothbrush H.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A cap sanitizer comprising:
a cap member having a bottom section, a middle section, and a top section, a cavity, an applying surface and a perforated membrane having apertures therein, and wherein said cavity comprises sanitizing solution disposed therewithin.

2. The cap sanitizer of claim 1, wherein said cavity and said applying surface are in fluid communication via said apertures.

3. The cap sanitizer of claim 2, further comprising:
a first o-ring disposed at said bottom section below said applying surface, wherein said first o-ring is adapted to seal against a dispenser bottle tip of a dispenser bottle when said dispenser cap sanitizer is secured to the dispenser bottle.

4. The cap sanitizer of claim 3, wherein said apertures are excluded from a central portion of said perforated membrane.

5. The cap sanitizer of claim 3, wherein said applying surface comprises a sponge, and wherein said cavity is disposed entirely within said top section.

6. The cap sanitizer of claim 5, wherein said perforated membrane is disposed in said top section and together with said top section defines said cavity.

7. The cap sanitizer of claim 2, wherein said cavity is disposed entirely within said middle section.

8. The cap sanitizer of claim 7, wherein said perforated membrane is disposed in said middle section and together with said middle section defines said cavity.

9. The cap sanitizer of claim 7, wherein said applying surface comprises a sponge, said cap sanitizer further comprising:
a first o-ring disposed at said bottom section below said sponge, wherein said first o-ring is adapted to seal against a dispenser bottle tip of a dispenser bottle when said dispenser cap sanitizer is secured to the dispenser bottle; and
a second o-ring, wherein said second o-ring is disposed above said sponge, and wherein said second o-ring seals against the dispenser bottle tip when said dispenser cap sanitizer is secured to the dispenser bottle.

10. The cap sanitizer of claim 3, wherein said cavity is disposed within said top and middle sections.

11. The cap sanitizer of claim 10, wherein said applying surface is continuous and is disposed within said middle and top sections.

12. The cap sanitizer of claim 11, wherein said perforated membrane is disposed in said top and middle sections and together with said top and middle sections defines said cavity.

13. A method of sanitizing, said method comprising the steps of:
providing a cap sanitizer comprising an applying surface, a cavity, a perforated membrane and a sanitizing solution disposed within said cavity, wherein said sanitizing solution passes through said perforated membrane to said applying surface; and
placing said cap sanitizer over an object to be sanitized.

14. The method of claim 13, wherein said applying surface comprises a sponge, and wherein the object comprises a dispenser bottle having a dispensing tip, said method further comprising the step of:
contacting the dispensing tip with said sponge.

15. The method of claim 14, further comprising the step of:
dispensing fluid from the dispenser bottle.

16. The method of claim 14, further comprising the step of:
securing said cap sanitizer to the dispenser bottle.

17. The method of claim 13, wherein the object comprises a toothbrush having bristles, and wherein said applying surface comprises stiff fibers, said method further comprising the step of:
rotating the toothbrush within said cap sanitizer.

18. A sanitizing cap comprising:
a top;
a middle comprising a sidewall;
a bottom;
a perforated membrane disposed in said middle substantially parallel to said sidewall;
a cavity defined by said perforated membrane and said sidewall; and
a sanitizing solution disposed between said perforated membrane and said sidewall.

19. The sanitizing cap of claim 18, further comprising:
a sponge, wherein said perforated membrane is disposed between said sponge and said sidewall, and wherein said sanitizing solution is in fluid communication with said sponge via said perforated membrane; and
a first o-ring disposed below said sponge and a second o-ring disposed above said sponge, wherein said first o-ring is adapted to seal against a tip portion of a dispenser bottle, and wherein said sponge contacts the tip portion when said sanitizing cap is secured to the dispenser bottle.

20. The sanitizing cap of claim 18, further comprising:
stiff fibers extending through said perforated membrane, wherein said stiff fibers engage bristles of a brush inserted into said sanitizing cap, and wherein said sanitizing solution passes through said perforated membrane along said stiff fibers.
